(19) United States
(12) Patent Application Publication
(10) Pub. No.: US 2014/0336988 A1
(43) Pub. Date: Nov. 13, 2014

(54) Service module for a level measuring device and automated service method

(71) Applicant: VEGA Grieshaber KG, Wolfach (DE)

(72) Inventors: Roland Welle, Hausach (DE); Joerg Boersig, Schapbach (DE); Christian Hoferer, Offenburg (DE); Karl Griessbaum, Muhlenbach (DE)

(73) Assignee: VEGA Grieshaber KG, Wolfach (DE)

(21) Appl. No.: 14/267,491

(22) Filed: May 1, 2014

(30) Foreign Application Priority Data
May 13, 2013 (EP) 13 167 507.6

(51) Int. Cl. G01D 9/00

(52) U.S. Cl. CPC G01D 9/00
USPC 702/188

(57) ABSTRACT

A service module is for a level measuring device, which after being connected to the level measuring device can identify automatically the level measuring device, the operating program version used by the level measuring device and a status message generated by the level measuring device. Then the service module determines on the basis of the status message, what data is required from the level measuring device in order to identify a status of the level measuring device, which status is associated with the status message. This data is received on a data storage unit, which unit can be analysed in the laboratory. A service engineer is not required on site.

### PRIORITY CLAIM

This application claims the benefit of the filing date of EP Patent Application Serial No. 13 167 507 filed 13 May 2013, the disclosure of which application is hereby incorporated herein by reference.

### FIELD OF INVENTION

The present invention relates to level measurement technology. The invention relates in particular to a service module for a level measuring device, a level measuring device having a service module, an automated service method for diagnosing a status associated with a status message generated by a level measuring device, a program element and a machine-readable medium.

### TECHNICAL BACKGROUND

If a level measuring device, in the following also denoted as level indicator, malfunctions during the level measurement, it is often possible to identify the source of the fault by analysing the recorded measurement data, analysing measurement data captured in future by the level indicator or analysing other data stored in the level indicator. For this purpose, a service engineer typically connects his/her computer to the field device via a wired interface and then starts to look for the fault. This procedure may take several days until the data obtained permits precise identification of the fault.

If the fault is then diagnosed, the service engineer may, for example, download new firmware onto the level indicator, or furnish the level indicator with a new set of parameters (parameterise the level indicator) or take other measures to rectify the fault.

### SUMMARY OF INVENTION

According to a first aspect of the invention, a service module for a level measuring device (level indicator) is indicated that comprises an interface, a processor and a data storage unit. The interface is designed to connect the service module to a suitable interface of an electronics unit of the level measuring device. The processor is designed to identify automatically the level measuring device after the service module is connected to the electronics unit. In addition, the processor is designed to identify automatically the operating program version used by the level measuring device and any status message that may have been generated by the level measuring device. This status message may be an error message, for instance.

In addition, the processor is designed to determine automatically on the basis of the status message (e.g. the error message), what data is required from the level measuring device in order to identify a status of the level measuring device, which status is associated with the status message (e.g. the fault associated with the error message). The data storage unit is designed to store the required data after the level measuring device has transmitted this required data to the service module via the interface of the service module.

In other words, the service module may be designed to be connected to the electronics unit of the level indicator and thereupon request and/or record fully automatically precisely that data that is used to identify, and if applicable even to rectify, a malfunction of the level indicator. This data may be, for instance, measurement data from the level indicator already stored in the level indicator, or measurement data from the level indicator acquired in the future or other data stored in the level indicator.

For this purpose, it may be necessary that the processor is programmed such that after the service module is connected to the level indicator (or more precisely to the electronics unit of the level indicator), the service module can initially identify the level indicator uniquely. The processor may also be able to identify what type of software is running on the level indicator and what error messages have been generated when by the level indicator and in what context. Based on this knowledge, the processor can then decide what data is needed in order to carry out a precise fault analysis. The processor can actively request the data from the level indicator and/or it waits until the desired data is generated by the level indicator and then retrieves it. The service module can also be designed such that for certain error messages it just “listens in”, i.e. it monitors which steps the level indicator performs at what times and what commands and data are generated and/or captured.

If the data required for the fault diagnosis is stored in the service module, it may be analysed in order to identify the fault and determine how it can be rectified.

According to one embodiment of the invention, the processor is designed to actuate the level indicator automatically to transmit the required data.

According to a further embodiment of the invention, the service module, and in particular the processor thereof, is designed to parameterise the level indicator automatically after being connected to the electronics unit.

This parameterisation may take place, for instance, when the source of the fault has been identified by the analysis of the data transmitted from the level indicator to the service module. The source of the fault can be identified directly by the service module if the service module has been programmed accordingly, or it can be provided that the data storage unit of the service module or the entire service module is presented to a maintenance service facility, which then performs the data analysis in order to identify the fault. In this process, the maintenance service facility can suitably reprogram the processor so that after the service module is subsequently connected to the electronics unit of the level indicator, fault rectification is performed, for example in the form of automatic parameterisation of the level indicator.

According to a further embodiment of the invention, the service module is designed to use the processor to transmit a new set of firmware to the level indicator automatically after the service module is connected to the electronics unit.

This can also take place, for example, after reconnecting the service module to the level indicator once the required data has been transmitted and stored and then analysed.

According to a further embodiment of the invention, the service module is designed to determine the time at which transmission of the required data to the service module is completed. This can also be done by suitable programming of the processor.

Furthermore, it should be pointed out that some or all of the program to be executed by the processor can be stored on the data storage unit.

According to a further embodiment of the invention, the service module is designed to output an acoustic or visual signal at the end of data transmission.

After the acoustic or visual signal is output, a user then knows that the service module can be removed again from the level indicator.

According to a further embodiment of the invention, the required data is measurement data from the level indicator.

According to a further embodiment of the invention, the required data is data stored on the level indicator.

According to a further embodiment of the invention, the service module further comprises an energy storage device that can charged via the level indicator.

According to a further embodiment of the invention, the service module comprises a further interface, for example a USB port, in order to charge the energy storage device via an external power source. This can be advantageous when the supply of power from the level indicator to the service module is not sufficient to cover the energy needs of the service module.

According to a further embodiment of the invention, the service module comprises a housing having a circular cross-section for inserting in a suitable housing of the level indicator. For example, the service module can be screwed on.

According to a further aspect of the invention, a level indicator is defined that has a service module as described above and below.

According to a further aspect of the invention, an automated service method is defined for diagnosing a fault associated with an error message generated by a level indicator. The first step in the method is automatic identification of the level indicator, the operating program version used by the level indicator and/or an error message generated by the level indicator. This is done, for instance, after the service module performing the method has been connected to the level indicator.

It is then determined automatically on the basis of the error message, what data is required from the level indicator in order to identify a fault of the level indicator, which fault is associated with the error message.

Then the required data is stored on a data storage unit once the level indicator has transmitted this data to the service module via a suitable interface.

It should be pointed out here that the method steps which are described above and below with regard to the service module and are performed by the processor or other components of the service module may likewise be part of the method described above.

According to a further aspect of the invention, a program element is defined which, when executed in the processor of a service module for a level indicator, actuates the service module to perform the method steps described above and below.

According to a further aspect of the invention, a machine-readable medium is defined on which a program element is stored which, when executed in the processor of a service module, actuates the service module to perform the steps described above and below.

Exemplary embodiments of the invention are described below with reference to the figures.

Where the same reference signs are used in different figures in the following description of the figures, they denote the same or similar elements. The same or similar elements may also be denoted by different reference signs, however.

### BRIEF DESCRIPTION OF DRAWINGS

FIG. 1 shows a top view of a service module for a level indicator according to an exemplary embodiment of the present invention.

FIG. 2 shows the bottom face of a service module according to an exemplary embodiment of the present invention.

FIG. 3 shows a level indicator having a service module according to an exemplary embodiment of the present invention.

FIG. 4 shows a level indicator having a service module connected thereto an exemplary embodiment of the present invention.

FIG. 5 shows a flow diagram of a method according to an exemplary embodiment of the present invention.

### DETAILED DESCRIPTION

The depictions in the figures are schematic and not to scale.

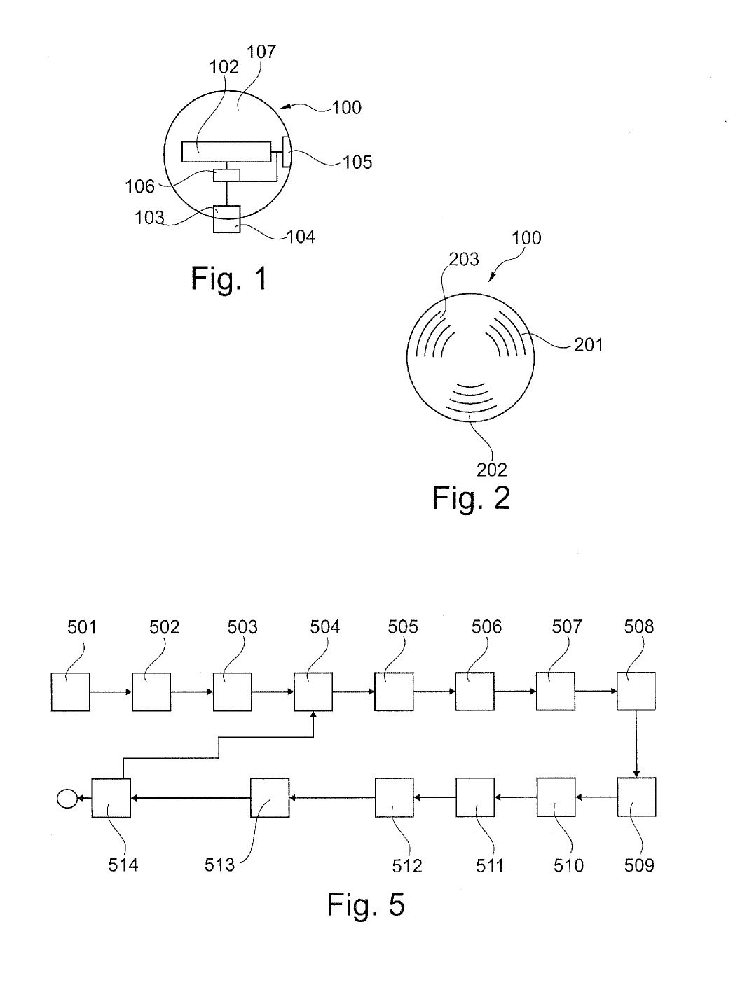

FIG. 1 shows a service module 100 for a level indicator according to an embodiment of the invention. The service module 100 has a circular cross-section and, for example, can be screwed or fitted onto the level indicator in the manner intended for a display module in the PLICSCOM range from the VEGA company.

The service module 100 comprises a housing 107 having a circular cross-section. Inside the housing is located a processor 106 that is connected to the energy storage device 102 for the supply of power. The processor 106 is also connected to an external interface 105, for example a USB port, via which it can likewise be supplied with power. It can be provided that the energy storage device 102 can be charged via the external interface 105.

In addition, the processor is connected to a second interface 103, into which can be plugged a data storage unit 104. This data storage unit may be a memory card, for instance. Instructions and/or data for the processor, which the processor can retrieve as required, are stored on this card. In particular, the processor can store on the data storage unit 104 data that it receives from the level indicator.

FIG. 2 shows the rear face of a service module according to an embodiment of the invention. The rear face of the service module in FIG. 2 comprises, for example, three or four interface groups 201, 202, 203, which are embodied in the form of sliding contacts for example. If the service module is screwed or fitted onto the level indicator, one of the three groups of sliding contacts is connected to the corresponding device interface of the level indicator. Each of these groups of contacts 201, 202, 203 is connected to the processor 106 and is used to connect the processor to the electronics unit of the level indicator.

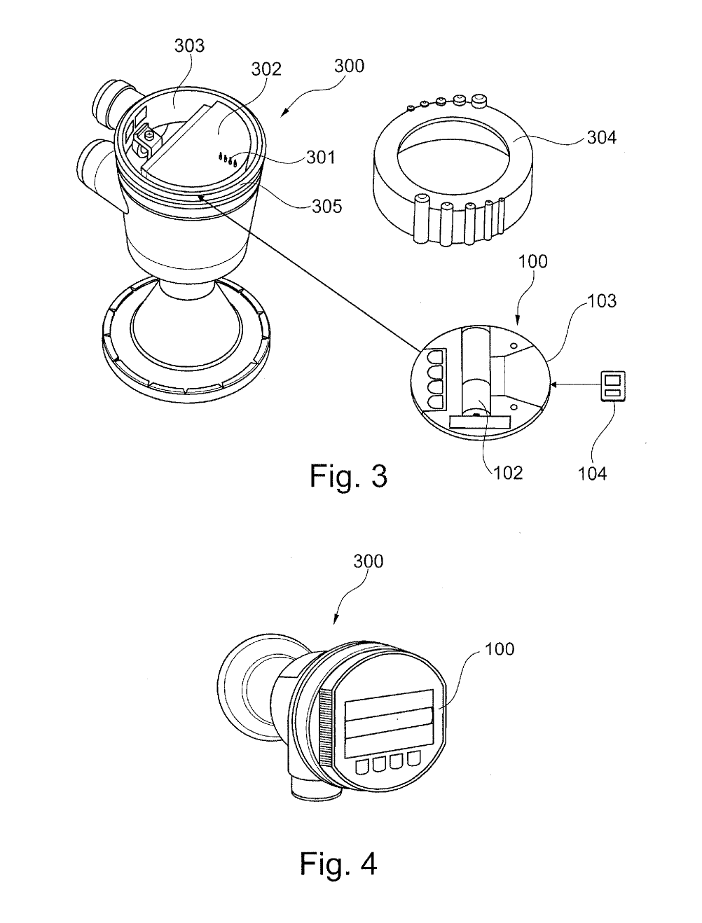

FIG. 3 shows a level indicator 300, for example a radar level indicator. The level indicator comprises a housing 303, onto which the service module 100 can be screwed, or into which the service module 100 can be inserted. If the service module is inserted, a housing cap 304 comprising (as shown) or not comprising a viewing window is provided, which is screwed onto the external thread 305 of the level indicator after inserting the service module into the level indicator, in order to protect the service module from external influences. The service module may be mechanically connected firmly to the electronics unit (302) by a suitable latching mechanism.

Four contact pins 301 are provided, which are used to make electrical contact with the interface of the service module (see sliding contacts 201, 202, 203 in FIG. 2) when the service module is fitted onto the level indicator.

The contact pins 301 are connected to the electronics unit 302 of the level indicator.

FIG. 3 also shows how the data storage unit 104 can be inserted into the interface 103 of the service module.

FIG. 4 shows the level indicator of FIG. 3 fitted with service module but without housing cap 304.

FIG. 5 shows the flow diagram of a method according to an embodiment of the invention. In step 501, the level indicator outputs an error message, whereupon in step 502, the service centre is notified automatically or manually by the user of the level indicator. In step 503, the service centre presents a service module to the user of the level indicator, who in step 504 connects the service module to the electronics unit of the level indicator. In step 505, the service module is supplied with power from the level indicator, and in step 506 the service program of the processor of the service module starts. First, the processor thereby automatically identifies the level indicator, the operating program version used by the level indicator, and the error message(s) generated by the level indicator.

In step 507, the processor determines automatically on the basis of the error message(s), what data is required from the level indicator in order to identify a fault of the level indicator, which fault is associated with the error message.

In step 508, the processor retrieves the data from the level indicator or waits until the level indicator has transmitted the relevant data to the service module, and stores this data on a data storage unit of the service module.

In step 509, a signal is sent by the service module that signals that all the necessary data is stored on the data storage unit. Then the entire service module or the data storage unit is removed and sent to the service centre, which in step 511 reads out the data and performs a fault diagnosis/fault identification.

In step 512, the service centre loads new data onto the data storage unit and sends the data storage unit back to the user of the level indicator. In step 513, the service module comprising the data storage unit, onto which new data has been written, is reconnected to the level indicator, whereupon in step 514, a fault-rectification program is started automatically in the processor of the service module, and the data required for rectifying the level-indicator fault is then transmitted automatically from the service module to the level indicator. This data may be parameterisation data and/or firmware data.

If the fault is still not rectified or a new error message occurs, the method can begin again at step 504.

Hence while the level indicator is running, the service module can collect all the data needed to form the measured value, and saves this data on a standard SD memory card, for instance. It is thereby possible to reconstruct in another place (e.g. in the laboratory, i.e. in the service centre) the sensor behaviour during the continuous level measurement.

The recording does not interfere with operation of the level indicator.

The service module has a new type of energy scheme. Peak currents of up to 60 mA are possible for storing data on an SD card. A rechargeable battery is available for this purpose as an energy storage device. The rechargeable battery is itself supplied with a constant current level by the sensor. This current would otherwise be available to a display module (for instance PLICSCOM). For a 4 . . . 20 mA indicator, the charging current depends on the loop current. The energy balance of the service module may sometimes be negative owing to the sometimes very fast data sequence, i.e. the high processor power. This means that the rechargeable battery is charged in advance in order to achieve as long a recording as possible.

The service module has the geometrical dimensions of the PLICSCOM, for example. It therefore fits into the platform concept of the VEGA sensors.

It should be pointed out here that the service module can be designed especially for instruments that are connected to a 4 . . . 20 mA measuring loop.

A possible service deployment may proceed as follows: a customer reports a problem with a sensor and thereupon is sent a service module that is used to read out and store the sensor data. Then the customer returns the service module or even just the data storage device, e.g. the SD card, or just the data held on the data storage device, to the service centre, where the data is analysed, and a solution to rectify the fault is devised on the basis of the analysis. The new parameter settings or software version for the level sensor is stored in the service module, and the service module or the memory card containing the data stored thereon is sent back to the customer. As soon as the service module is reconnected to the sensor to be parameterised (the service module identifies this, for instance, from the serial number of the sensor), it performs the steps defined in the service centre (for example software update, parameter download).

The service module itself is parameterised, for example, by means of the memory card on which the sensor data is also stored.

One advantage of the invention can be considered to be the fact that there is no need to perform recording using a wired connection e.g. by a PC. This avoids effects such as EMC interference that can arise with cables. The recording does not impede the actual measurement of the level.

A data port (e.g. USB port) is possible as a particular embodiment. While it can be provided as a pure communications interface for communication between field device and an external operating unit (e.g. PC having suitable operating software, or hand-held operating unit, smartphone and the like), it can also ensure that the service module itself can be parameterised. Furthermore, depending on the specification (for instance USB port) of the data port, i.e. of the external interface of the service module, the data port itself provides the facility to charge the energy storage device of the service module.

In addition, it should be mentioned that the terms “comprising” and “having” do not exclude any other elements or steps, and “a” or “an” does not rule out more than one. It should also be pointed out that features or steps that have been described with reference to one of the above embodiments can also be used in combination with other features or steps of other embodiments described above. Reference signs in the claims shall not be deemed to have a limiting effect.

1. A service module for a level measuring device, comprising:
an interface connecting the service module to an electronics unit of the level measuring device;
a processor configured to identify automatically the level measuring device, an operating program version used by the level measuring device and a status message generated by the level measuring device, after the service module is connected to the electronics unit, the processor is further being configured to determine automatically on the basis of the status message, what data is required from the level measuring device in order to identify a status of the level measuring device, which status is associated with the status message; and
a data storage unit storing the required data after the level measuring device has transmitted this data to the service module via the interface.

2. The service module according to claim 1, wherein the processor is configured to actuate the level measuring device automatically to transmit the required data.

3. The service module according to claim 1, wherein the service module is configured to parameterise the level measuring device automatically after the service module is connected to the electronics unit.

4. The service module according to claim 1, wherein the service module is configured to transmit a new set of firmware to the level measuring device automatically after the service module is connected to the electronics unit.

5. The service module according to claim 1, wherein the service module is configured to determine the time at which transmission of the required data to the service module is completed.

6. The service module according to claim 5, wherein the service module is configured to output an acoustic or visual signal at the end of data transmission.

7. The service module according to claim 1, wherein the required data is measurement data from the level measuring device.

8. The service module according to claim 1, wherein the required data is data stored on the level measuring device.

9. The service module according to claim 1, further comprising:
an energy storage device charged via the level measuring device.

10. The service module according to claim 9, further comprising:
a USB port, the energy storage device being charged using the USB port.

11. The service module according to claim 1, further comprising:
a housing having a circular cross-section for inserting in a corresponding housing of the level measuring device.

12. A level measuring device, comprising:
a service module according to claim 1.

13. An automated service method for diagnosing a status of a field device, which status is associated with a status message generated by the field device, comprising the steps:
automatically identifying the field device, the operating program version used by the field device and a status message generated by the field device;
automatically determining on the basis of the status message, what data is required from the field device in order to identify a function of the field device, which function is associated with the status message; and
storing the required data after the field device has transmitted this data to the service module via the interface.

14. A program element which, when executed in a processor of a field device, instructs the field device to perform the following steps:
automatically identifying the field device, the operating program version used by the field device and a status message generated by the field device;
automatically determining on the basis of the status message, what data is required from the field device in order to identify a function of the field device, which function is associated with the status message; and
storing the required data after the field device has transmitted this data to the service module via the interface.

15. A machine-readable medium on which a program element is stored which, when executed in the processor of a field device, instructs the field device to perform the following steps:
automatically identifying the field device, the operating program version used by the field device and a status message generated by the field device;
automatically determining on the basis of the status message, what data is required from the field device in order to identify a function of the field device, which function is associated with the status message; and
storing the required data after the field device has transmitted this required data to the service module via the interface.
